(19) United States
(12) Patent Application Publication
(10) Pub. No.: US 2002/0193001 A1
(43) Pub. Date: Dec. 19, 2002

(54) Method and device for connecting solar battery modules

(75) Inventors: Hiroyuki Yoshikawa, Yokkaichi-city (JP); Makoto Higashikozono, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, LTD., Yokkaichi-city (JP)

(21) Appl. No.: 10/171,551

(22) Filed: Jun. 17, 2002

(30) Foreign Application Priority Data
Jun. 18, 2001 (JP) 2001-183163

(51) Int. Cl. H01R 13/60

(52) U.S. Cl. 439/540.1

(57) ABSTRACT

An improved method and structure for connecting a prescribed number of solar battery modules in series. Corresponding electrical connectors are attached to the terminal ends of cables extending from each solar battery module in the system and to the ends of relay cables that are joined in series to form a relay cable assembly. The relay cable assembly is thus able to provide a sequential series of connector pairs whose number equals the number of solar battery modules to be connected. The series joined relay cables in the relay cable assembly are connected to the output cables of each solar battery module in the system, thus providing an improved method of connecting a prescribed number of solar battery modules in series.

### BACKGROUND OF THE INVENTION

1. Field of the Invention

The invention relates to a method of, and apparatus for, mutually connecting, in electrical series, a prescribed number of multiple household-use rooftop solar battery modules.

2. Discussion of Background Information

There is a known type of solar based electrical power generating system that consists of multiple solar battery modules commonly placed on the roof of a house or other structure in a matrix configuration. The solar battery module used in this type of system is normally equipped with a terminal box from which electrical power is output, and a pair of power output cables that extend from the terminal box to carry electrical power from the module to an external location. The terminal box may be equipped, as is required by some applications, with a bypass diode and a reverse current protector diode. This type of solar battery module has been publicly disclosed by Japanese Utility Patent No.60-179053 and Japanese Patent Publication No. 3-25031.

FIG. 10 depicts a known arrangement of solar battery modules 1 in which terminal box 3 is installed on the rear surface of each module body 2, module output cables 4a and 4b extend outward from each terminal box 3, and male connector 5 and female connector 6 are installed to the ends of each cable 4a and 4b respectively.

To carry electrical power from each solar battery module 1, male connector 5 on output cable 4a from first solar battery module 1 is connected to female connector 6 on output cable 4b of second solar battery module 1, and male connector 5 on output cable 4a from second solar battery module 1 is connected to female connector 6 on output cable 4b of third solar battery module 1. This series connection pattern is sequentially repeated between each pair of solar battery modules 1 in order to obtain electrical power from a prescribed number of solar battery modules connected in series.

Because the amount of electricity output by a single solar battery module is relatively small, it becomes necessary to connect multiple solar battery modules 1 in series to obtain a sufficient amount of electrical power. There is a problem associated with this connecting operation in that the number of connections required to join solar battery modules 11 can be easily miscounted and confused.

### SUMMARY OF THE INVENTION

The purpose of the present invention is to provide a method and structure by which a prescribed number of solar battery modules can be connected in series with reduced chance of confusion and error relating to the number of connections required. To this end, the present invention proposes a structure whereby relay cables, each provided with terminal connectors for connection to the ends of the solar battery module output cables, are sequentially joined to form a relay cable assembly that attaches to the terminal ends of the module output cables in a series connection configuration in which the number of relay cables in the relay cable assembly is equivalent only to the number of solar battery modules to be connected in series, and whereby the output cables of each solar battery module are sequentially connected in series by the relay cable assembly.

Moreover, a male and female connector respectively attached to the terminal end of each solar module output cable form an output cable connector pair. Each relay cable is equipped with a male connector attached to one end and a female connector to the other, the relay cable male connector being connected to the output cable female connector, and the relay cable female connector being connected to the output cable male connector. The relay cable assembly may be formed as a structure in which each male and female connector of differing relay cables are sequentially joined as a pair of connectors maintained in adjacent parallel alignment by a clamp or integrally molded connector member.

Furthermore, the male and female connectors attached to the solar battery module may be held in adjacent parallel alignment as a pair of connectors by the aforesaid clamp or integrally molded connector member.

A connecting method is also possible whereby the connectors attached to the extending ends of the module output cables may take the form of bi-pole connectors whose number corresponds to the number of bi-pole connectors provided by the relay cable assembly.

In another aspect of the present invention, a clamp is provided in combination with a pair of cables each having at least one connector for connecting to a solar battery module, each connector including at least one clamp groove. The clamp may include a pair of joint receptacles, each joint receptacle configured to receive a respective one of the connectors, and wherein each joint receptacle resiliently engages the clamp groove of a respective connector to maintain the connectors in a parallel arrangement and to prevent longitudinal displacement of the connectors relative to the clamp. Each connector may further include at least one rib positioned within the clamp groove, and the joint receptacles may further include a groove that receives the rib to thereby prevent rotation of the respective connector relative to the clamp.

According to another aspect of the present invention, the combination may further include the clamp being connected at one end of a bridge piece, and a pair of second joint receptacles provided at an opposite end of the bridge piece, with the pair of second joint receptacles being configured to clampingly receive cables connected to the connectors received in the first mentioned joint receptacles to thereby maintain the connectors and adjacent portion of the cables connected thereto in parallel relation. Additionally, the clamp may formed unitarily and in one piece, and the clamp may be formed from a resilient synthetic resin material.

According to yet another aspect of the present invention, a clamp is provided for connecting a pair of cables, each cable having at least one connector for connecting to a solar battery module, and each connector including at least one clamp groove and at least one rib positioned within the clamp groove. The clamp includes a pair of first joint receptacles, each first joint receptacle configured to receive a respective one of the connectors, and wherein each first joint receptacle resiliently engages the clamp groove of a respective connector to maintain the connectors in a parallel arrangement and to prevent longitudinal displacement of the connectors relative to the clamp. The first joint receptacles may further include a groove configured to receive the rib of a respective connector to thereby prevent rotation of the respective connector relative to the clamp.

In a further aspect of the present invention, the clamp may further include a bridge piece connected at one end thereof, and a pair of second joint receptacles are provided at an opposite end of the bridge piece, the pair of second joint receptacles being configured to clampingly receive cables connected to the connectors received in the first joint receptacles to thereby maintain the connectors and adjacent portion of the cables connected thereto in parallel relation. The clamp may be formed unitarily and in one piece, and the clamp may also be formed from a resilient synthetic resin material.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention in which like reference numerals represent similar parts throughout the several views of the drawings, and wherein:

FIG. 1 is an explanatory drawing of the relay cable assembly according to the first embodiment.

FIG. 2 is an explanatory drawing of the cable connection method according to the first embodiment.

FIG. 3 is a side view of the relay cable according to the first embodiment.

FIG. 4 is an explanatory drawing of the relay cable joining method.

FIG. 5 is a plan view of the joined cables.

FIG. 6 is a cross section taken along the line VI-VI of FIG. 5.

FIG. 7 is an explanatory drawing of the connecting method according to the second embodiment.

FIG. 8 is an explanatory drawing of the cable joining method according to the third embodiment.

FIG. 9 is an explanatory drawing of the cable connection method according to the fourth embodiment.

FIG. 10 is an explanatory drawing of the conventional method of connecting solar battery modules.

FIG. 11 is a top plan view of an alternative form of clamp structure utilized to connect solar battery modules in accordance with the present invention.

FIG. 12 is a partial cross-sectional view of clamp structure of FIG. 11, taken along the line XII-XII of FIG. 11.

FIG. 13 is a partial cross-sectional view of clamp structure of FIG. 11, taken along the line XIII-XIII of FIG. 11.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

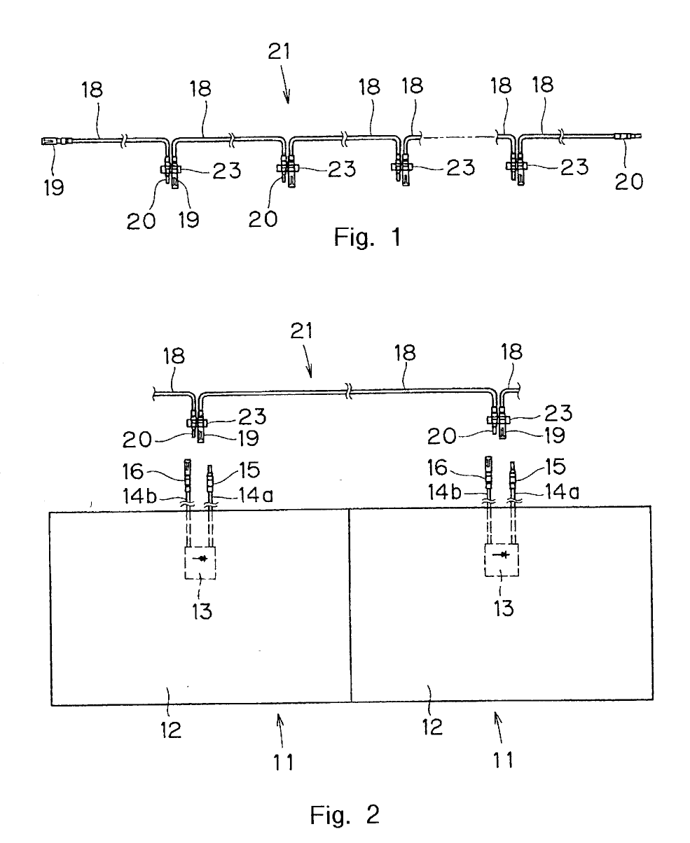

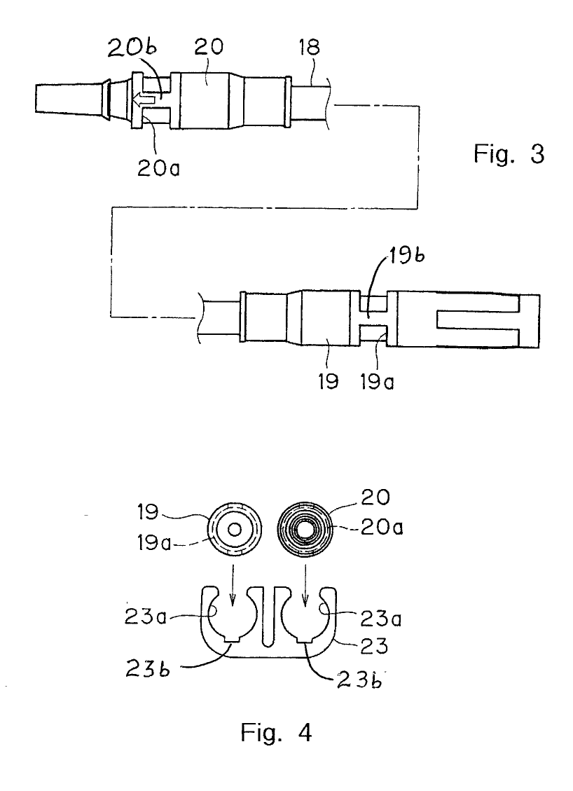

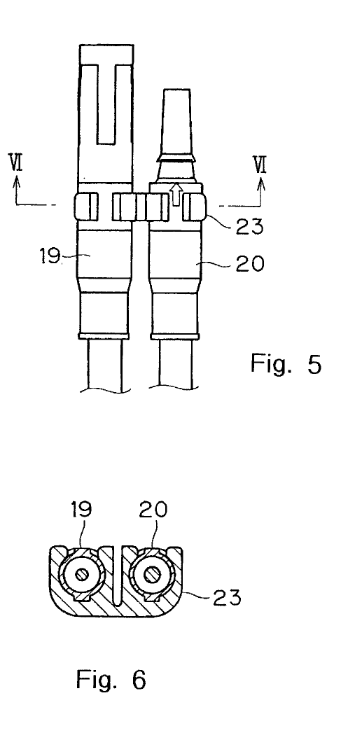

The following describes a first embodiment of the present invention with reference to FIGS. 1 through 6. Similar to the structure of a conventional solar battery module, output cables 14a and 14b extend an appropriate length from terminal box 13 located on the rear surface of module body 12 of solar battery module 11. Male connector 15 and female connector 16 are attached to the extended ends of each cable 14a and 14b respectively.

Relay cables 18 are provided at an appropriate length for connection to each solar battery module 11, one end of each relay cable 18 being equipped with female connector 19 that can be removably connected to male connector 15, and the other end with male connector 20 that can be removably connected to female connector 16.

When laying out and connecting each of a prescribed number of solar battery modules 11 in series, relay cable assembly 21 is first constructed by mutually joining, in series, a number of relay cables 18 that corresponds to the number of solar battery modules 11 to be connected. This is the relay cable assembly process.

As shown in FIGS. 4 through 6, clamp 23, made, for example, from a resilient material such as plastic resin or other like substance, is used as means of mutually retaining relay cables 18. Clamp 23 incorporates a pair of joint receptacles 23a aligned on the same plane into which flexible clamp grooves 19a and 20a of female connector 19 and male connector 20 are respectively inserted, the clamp grooves being formed as annular channels located on the periphery of the axially central region of the female and male connectors. In this embodiment clamp groove 19a and 20a are formed to the same dimensions. Additionally, the female connector 19 and the male connector 20 each include a rib 19b and 20b, respectively, and the clamp 23 includes a pair of grooves 23b. When the female connector 19 and male connector 20 are inserted into the clamp 23, the ribs 19b and 20b interfit with the grooves 23b (note FIG. 6) to prevent rotation of the respective connectors relative to the clamp 23. Thus, longitudinal and rotational displacement of the female connector 19 and male connector 20 relative to the clamp 23 are substantially prevented by engagement of the clamp 23 with the clamp grooves 19a, 20a and the ribs 19b, 20b.

To sequentially maintain the ends of relay cables 18 in a series connected configuration, female connector 19 on one end of relay cable 18 is inserted into joint receptacle 23a in clamp 23, and male connector 20 on the end of another relay cable 18 is inserted into the adjacent joint receptacle of the same clamp. The repeated insertion of pairs of connectors into each clamp 23 in this manner results in the formation of relay cable assembly 21 that ultimately includes a prescribed number of relay cables 18 connected sequentially in series. This type of connective structure provides means by which each female connector 19 and male connector 20 of differing relay cables can be retained in parallel alignment by clamp 23 as connector pairs.

The number of relay cables 18 that are used to initially construct relay cable assembly 21 is one more than the number of solar battery modules 11 to be connected in series. As described by FIGS. 1 and 2, the number of locations at which female connector 19 and male connector 20 are paired in clamp 23 are equivalent to the number of solar battery modules 11 to be connected in series. The female connector 19 and male connector 20 located at the extremities of cable assembly 21 are used as the cable array connectors.

To sequentially connect each of solar battery modules 11 in series, each pair of female and male connectors 19 and 20 (that are installed to each clamp 23 of relay cable assembly 21) is sequentially connected, in series, to each pair of male and female connectors 15 and 16 of each solar battery module. A series connection of solar battery modules 11 is thus achieved with female and male connectors 19 and 20 joined in clamp 23. This operation is the solar batter module series connection process. Subsequently, the female and male connectors 19 and 20 located at the extremities of the relay cable assembly may be connected to the cable array.

A prescribed number of solar battery modules 11 may also be connected in series by means of relay cable assembly 21 as is subsequently explained. As explained previously, relay cable assembly 21 is first constructed as an assemblage of the required number of relay cables 18, that is, a number equal to the number of solar battery modules plus one, thus providing for the sequential series connection of each solar battery module 11 through relay cable assembly 21. Because the series connection of solar battery modules 11 is completed after female and male connectors 19 and 20 (retained by each clamp 23 of hook-up cable assembly 21) are connected to female and male connectors 15 and 16 of each solar battery module 11, there is no need to count the number of connections as is required with a conventional connection method. Full attention can thus be devoted to the procedure through which connectors 15 and 16 are joined to 19 and 20. This makes the connecting operation easier and allows solar battery modules 11 to be series connected with improved accuracy, even in cases where there are many solar battery modules to be connected.

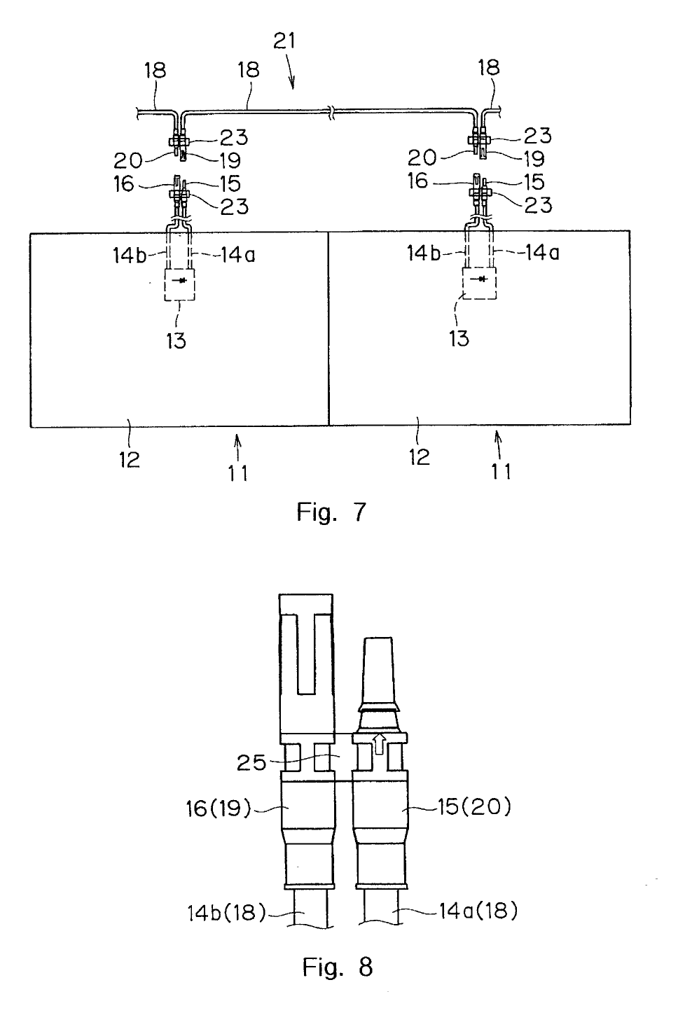

FIG. 7 depicts a second embodiment of the invention in which descriptions of components and structures that are identical to and carry the same identification numbers as those of the first embodiment have been omitted.

In this second embodiment, clamp 23 is used to maintain male connector 15 and female connector 16 as a connector pair, connectors 15 and 16 being respectively attached to the terminal ends of output cables 14a and 14b of solar battery module 11. As each connector 15 and 16 of solar battery module 11 and each connector 19 and 20 of relay cable assembly 21 form respective connector pairs through their insertion into clamp 23, pairs of cables can be mutually joined in the same manner as if one-piece connectors were used. This results in the overall solar battery module connection operation becoming equivalent to one using bi-pole connectors, a fifty percent reduction in the number of connections that must be made when compared to connecting method in which single connectors are used, and a highly efficient method of connecting each solar battery module 11 in series. Furthermore, while this connecting method provides the same advantages as one using bi-pole connectors, it does so at lower cost.

FIG. 8 depicts a third embodiment of the invention in which descriptions of components and structures that are identical to and carry the same identification numbers as those of the first embodiment have been omitted. In this third embodiment, the connectors 15 and 16 are mutually joined to form a one-piece structure, as are each connector 19 and 20, by means of integrally molded connector member 25.

Relay cable assembly 21, including of relay cables 18 sequentially joined in series, can be configured to connect the prescribed number of solar battery modules 11 by cutting molded connector member 25 at a location that will provide the number of relay cables 18 corresponding to the number of solar batteries 11 to be connected in series. This third embodiment provides the same advantages as noted in the description of the second embodiment.

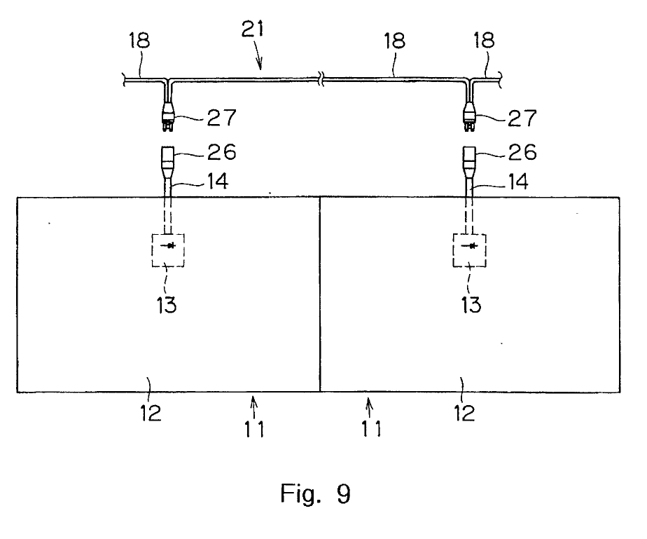

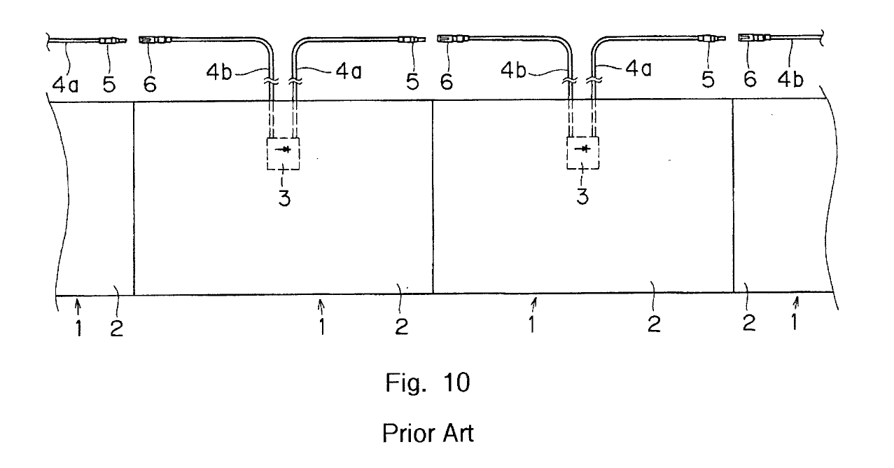

FIG. 9 depicts a fourth embodiment of the invention in which descriptions of components and structures that are identical to and carry the same identification numbers as those of the first embodiment have been omitted. In this fourth embodiment connectors 15 and 16 are combined to form bi-pole connector 26, connectors 19 and 20 are combined to form bi-pole connector 27, and the aforesaid output cables 14a and 14b are formed as a single output cable 14.

This fourth embodiment provides the same benefits as explained previously in regard to the third embodiment in that relay cable assembly 21, consisting of relay cables 18 sequentially joined in series, can be configured to connect the prescribed number of solar battery modules by cutting bi-pole connector 27 at a location that will provide a number of relay cables 18 corresponding to the number of solar batteries 11 to be connected.

Moreover, while the embodiments presented here describe a structure in which the required number of relay cables 18 are assembled in series through the joined pairs of connectors 19 and 20, the locations where relay cables 18 are joined need not be limited to those noted in these embodiments. Furthermore, the manner in which connectors 15 and 16 are joined, and also in which connectors 19 and 20 are joined, are not limited to the clamp 23 nor to integrally molded connector member 25.

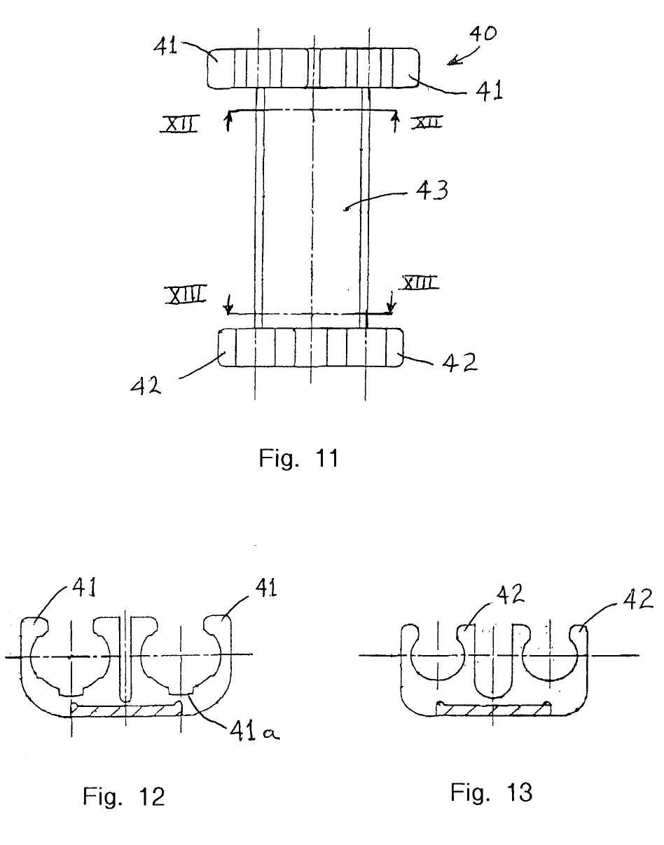

An alternative arrangement for a clamp to form a relay cable assembly is depicted in FIGS. 11-13 of the drawings. In this embodiment, an elongate clamp 40 includes a pair of first joint receptacles 41 provided at one end and configured in a similar manner to the joint receptacles 23a described above, and including grooves 41a which correspond to the grooves 23b described above. At the other end of the clamp 40, a pair of second joint receptacles 42 is provided, which second joint receptacles are configured to clampingly receive the cables of the cable relay assembly which are connected to the female and male connectors 19, 20. A bridge piece 43 is provided to interconnect the first and second joint receptacles 41, 42 and to provide the proper spacing therebetween. The elongate clamp 40 is formed from a suitable resilient material, for example a synthetic resin material, and is configured such that respective female and male connectors 19, 20, and the cables attached thereto, are clampingly received in the respective first and second joint receptacles to maintain the connectors and the adjacent portions of the cables connected thereto in parallel relation. Thus, the cable relay assembly is easily aligned with the solar battery modules, and efficient connection thereto can be effected.

In summation, the present invention proposes a method of sequentially connecting the output cables of solar battery modules in series by an attaching a relay cable assembly, including a number of relay cables equivalent to the number of solar battery modules to be connected, to the connectors installed to the extending ends of the output cables. There are numerous benefits that result from connecting each relay cable in the series-configuration relay cable assembly to the output cables from the solar battery modules, and from the prescribed number of solar modules being in a finished series connected condition when the connection operation is completed. These benefits include 1) the elimination of the need to make connections while counting the number of connections as is conventionally required, 2) the ability to pay full attention to the connecting procedure, 3) a simplified solar battery module connecting procedure, and 4) the ability to connect a prescribed number of solar battery modules with greater accuracy. All of these benefits are realized even when there are a large number of solar battery modules to be connected in series.

Moreover, a connector pair is formed through the attachment of respective male and female connectors to the ends of the output cable. A male connector that attaches to a female output cable connector is installed to one end of each relay cable, and a female connector that attaches to a male output cable connector is installed to the other end, the male and female connectors of differing relay cables being maintained in adjacent parallel alignment through a clamp or integrally molded connecting member to form a sequential series joined relay cable assembly. The male and female connectors attached to the solar battery module are maintained as a pair of connectors in adjacent parallel alignment through a clamp or integrally molded connecting member, thus providing for a structure that allows each solar battery module connector pair to be joined to each relay cable assembly connector pair in the same manner as would be done with bi-pole connectors. This connecting method requires that only half the number of connections be made as compared to the method in which single connectors are joined individually, provides a more efficient method of connecting solar battery modules in a sequential series, and provides the same benefits as would be realized if bi-pole connectors were used, but without the increased cost.

Moreover, the connectors attached to the output cables may be provided in the form of bi-pole connectors that join to corresponding bi-pole connectors attached to the ends of the relay cables that make up the relay cable assembly. This configuration provides the same assembly efficiency benefits as explained previously in regard to the operation applied to connect solar battery modules in series.

It is noted that the foregoing examples have been provided merely for the purpose of explanation and are in no way to be construed as limiting embodiments of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

The present application claims priority under 35 U.S.C. §119 of Japanese Patent Application No. JP 2001-183163, filed on Jun. 18, 2001, the disclosure of which is expressly incorporated by reference herein in its entirety.

We claim:

1. A method of connecting a prescribed number of solar battery modules having output cables by sequentially joining the output cables of respective modules in series, the method comprising:
forming a relay cable assembly, said relay cable assembly including multiple relay cables joined in series;
providing said relay cable assembly with a number of connectors for attachment to the output cables, said number of connectors equaling the number of solar battery modules to be connected in series; and
connecting said connector of said relay cable assembly to the output cables of each solar battery module in sequential series.

2. The solar battery module connecting method according to claim 1, wherein
the male and female connectors attached to extending ends of the output cables form connector pairs, and
each of the relay cables is equipped with a male connector for attachment to the output cable female connector, and a female connector for attachment to the output cable male connector, each male and female connector of differing relay cables being maintained as a pair of connectors in adjacent parallel alignment by at least one of a clamp and an integrally molded connector member.

3. The solar battery module output cable connecting method according to claim 2, wherein the male and female connectors of the solar battery module are maintained in adjacent parallel alignment by said at least one clamp or integrally molded connector member.

4. The solar battery module output cable connecting method according to claim 1, wherein bi-pole connectors installed to the output cables attach to corresponding bi-pole connectors installed to the extending ends of said relay cable assembly.

5. In combination with a pair of cables each having at least one connector for connecting to a solar battery module, each connector including at least one clamp groove:
a clamp including a pair of joint receptacles, each joint receptacle configured to receive a respective one of the connectors, and wherein each joint receptacle resiliently engages the clamp groove of a respective connector to maintain the connectors in a parallel arrangement and to prevent longitudinal displacement of the connectors relative to the clamp.

6. The combination according to claim 5, wherein each connector further includes at least one rib positioned within the clamp groove, and wherein said joint receptacles further include a groove that receives the rib to thereby prevent rotation of the respective connector relative to the clamp.

7. The combination according to claim 6, wherein said clamp is connected at one end of a bridge piece, and a pair of second joint receptacles are provided at an opposite end of said bridge piece, said pair of second joint receptacles being configured to clamplingly receive cables connected to the connectors received in the first mentioned joint receptacles to thereby maintain the connectors and adjacent portion of the cables connected thereto in parallel relation.

8. The combination according to claim 6, wherein said clamp is formed unitarily and in one piece.

9. The combination according to claim 8, wherein said clamp is formed from a resilient synthetic resin material.

10. The combination according to claim 7, wherein said clamp is formed unitarily and in one piece.

11. The combination according to claim 10, wherein said clamp is formed from a resilient synthetic resin material.

12. A clamp for connecting a pair of cables, each cable having at least one connector for connecting to a solar battery module, and each connector including at least one clamp groove and at least one rib positioned within the clamp groove, said clamp comprising:
a pair of first joint receptacles, each first joint receptacle configured to receive a respective one of the connectors, and wherein each first joint receptacle resiliently engages the clamp groove of a respective connector to maintain the connectors in a parallel arrangement and to prevent longitudinal displacement of the connectors relative to the clamp.

13. The clamp according to claim 12, wherein said first joint receptacles further include a groove configured to receive the rib of a respective connector to thereby prevent rotation of the respective connector relative to said clamp.

14. The clamp according to claim 13, wherein said clamp further comprises a bridge piece connected at one end thereof, and a pair of second joint receptacles are provided at an opposite end of said bridge piece, said pair of second joint receptacles being configured to clamplingly receive cables connected to the connectors received in said first joint receptacles to thereby maintain the connectors and adjacent portion of the cables connected thereto in parallel relation.

15. The clamp according to claim 12, wherein said clamp is formed unitarily and in one piece.

16. The clamp according to claim 15, wherein said clamp is formed from a resilient synthetic resin material.

17. The clamp according to claim 14, wherein said clamp is formed unitarily and in one piece.

18. The clamp according to claim 17, wherein said clamp is formed from a resilient synthetic resin material.
